(19) United States
(12) Patent Application Publication
(10) Pub. No.: US 2018/0343140 A1
(43) Pub. Date: Nov. 29, 2018

(54) METHOD AND APPARATUS FOR REMOTE CONTROL OF OPERATIONAL CHARACTERISTICS OF A PREMISES

(71) Applicant: Slick Spaces Technologies Inc., Vancouver (CA)

(72) Inventors: Michael Driedger, Vancouver (CA); Mathew Hunter, Vancouver (CA)

(21) Appl. No.: 15/827,963

(22) Filed: Nov. 30, 2017

Related U.S. Application Data
(60) Provisional application No. 62/510,847, filed on May 25, 2017.

(51) Int. Cl. H04L 12/28; G06F 3/0484; H04L 29/08

(52) U.S. Cl. CPC H04L 12/2818; H04L 2012/2841; H04L 67/125; G06F 3/0484

(57) ABSTRACT

Systems, methods and apparatuses for remote control of operational characteristics of a premises are disclosed. Embodiments provide for the remote authorization of access to a premises or remote adjustment of one or more characteristics of a premises. Embodiments can provide for the substantially automatic adjustment of one or more characteristics of the premises upon the performance of a particular action. Embodiments can further provide for remote monitoring of a premises.

### CROSS REFERENCE TO RELATED APPLICATIONS

This application claims the benefit of priority to U.S. Provisional Patent Application Ser. No. 62/510,847 entitled “Method and Apparatus for Remote Control of Operational Characteristics of a Premises” filed May 25, 2017, which is hereby incorporated by reference in its entirety.

### FIELD OF THE INVENTION

The present invention pertains to the field control systems and in particular to methods and apparatuses for remote control of operational characteristics of a premises.

### BACKGROUND

Home automation is becoming more prevalent today and the number and kinds of smart home devices is growing. Some of these devices can enable one to control a number of systems within a home for example, lighting systems and heating systems, from your smart phone using a user interface which interconnects with the respective system. However, these systems, while enabling access to these functionalities of your home, typically require one to access the control parameters relating to the particular system.

Therefore there is a need for a method and apparatus that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and apparatus for remote control of operational characteristics of a premises. In accordance with an aspect of the present invention, there is provided a method for remote control of one or more operational characteristics of a premises. The method includes receiving, by a central server, a notification for an action to be performed, the action relating one or more operational characteristics of the premises. The method further includes determining, by the central server, validity of the notification and transmitting, by the central server, instructions indicative of the action to be performed upon determination of validity of the notification.

In accordance with another aspect of the present invention there is provided a server for remote control of one or more operational characteristics of a premises. The server includes a processor and machine readable memory storing machine executable instructions which when executed by the processor configure the server to receive a notification for an action to be performed, the action relating one or more operational characteristics of the premises and determine validity of the notification. The machine executable instructions which when executed by the processor further configure the server to transmit instructions indicative of the action to be performed upon determination of validity of the notification.

In accordance with another aspect of the present invention, there is provided a method for remote control of one or more operational characteristics of a premises. The method including receiving, by a local hub, a notification from a locking system, the notification indicative of a transition of the locking system from a first state to a second state. The method further includes determining, by the local hub, one or more actions to be performed, the one or more actions indicative of a desired change in the one or more operational characteristics due to the transition of the locking system and transmitting, by the local hub, one or more commands indicative of the one or more actions.

In accordance with another aspect of the present invention there is provided a hub for remote control of one or more operational characteristics of a premises. The hub includes a processor and machine readable memory storing machine executable instructions which when executed by the processor configure the hub to receive a notification from a locking system, the notification indicative of a transition of the locking system from a first state to a second state and determine one or more actions to be performed, the once or more actions indicative of a desired change in the one or more operational characteristics due to the transition of the locking system. The machine executable instructions which when executed by the processor further configure the hub to transmit one or more commands indicative of the one or more actions.

In accordance with another aspect of the present invention there is provided a system for remote control of one or more operational characteristics of a premises. The system includes a locking system associated with the premises, the locking system transitionable between a first state to a second state and a local hub communicatively connected to the locking system. The system further includes a controller communicatively connected to the local hub, the controller operative to control at least one of the one or more operational characteristics, wherein the local hub is configured to transmit one or more commands to the controller upon transition of the locking system from the first state to the second state, the one or more commands indicative of a desired change in the one or more operational characteristics.

### BRIEF DESCRIPTION OF THE FIGURES

Further features and advantages of the present invention will become apparent from the wing detailed description taken in combination with the appended drawings, in which:

FIG. 1 illustrates a system for remote control of one or more operational characteristics of a premises in accordance with embodiments of the present invention.

FIG. 2 illustrates a signalling diagram for remote control of one or more operational characteristics of a premises in accordance with embodiments of the present invention.

FIG. 3 illustrates a signalling diagram for remote control of one or more operational characteristics of a premises in accordance with embodiments of the present invention.

FIG. 4 illustrates a logic flow diagram for provision of guest access to a premises in accordance with embodiments of the present invention.

FIG. 5 is a schematic diagram of a hardware device, in accordance with embodiments of the present invention.

It will be noted that throughout the appended drawings, like features are identified by like reference numerals.

### DETAILED DESCRIPTION OF THE INVENTION

The present invention provides methods, apparatuses and a system for remote control of operational characteristics of a premises. Embodiments provide for the remote authorization of access to a premises or remote adjustment of one or more characteristics of a premises. Embodiments can provide for the substantially automatic adjustment of one or more characteristics of the premises upon the performance of a particular action. Embodiments can further provide for remote monitoring of a premises.

According to embodiments of the present invention, an operational characteristic can be selected from a variety of operational characteristics of a premises. For example, an operational characteristic can relate to lighting, heating, sound or visual generation, (e.g. music, television), humidity, blind operation, locking systems, security systems or other operational characteristic as would be readily understood by a worker skilled in the art.

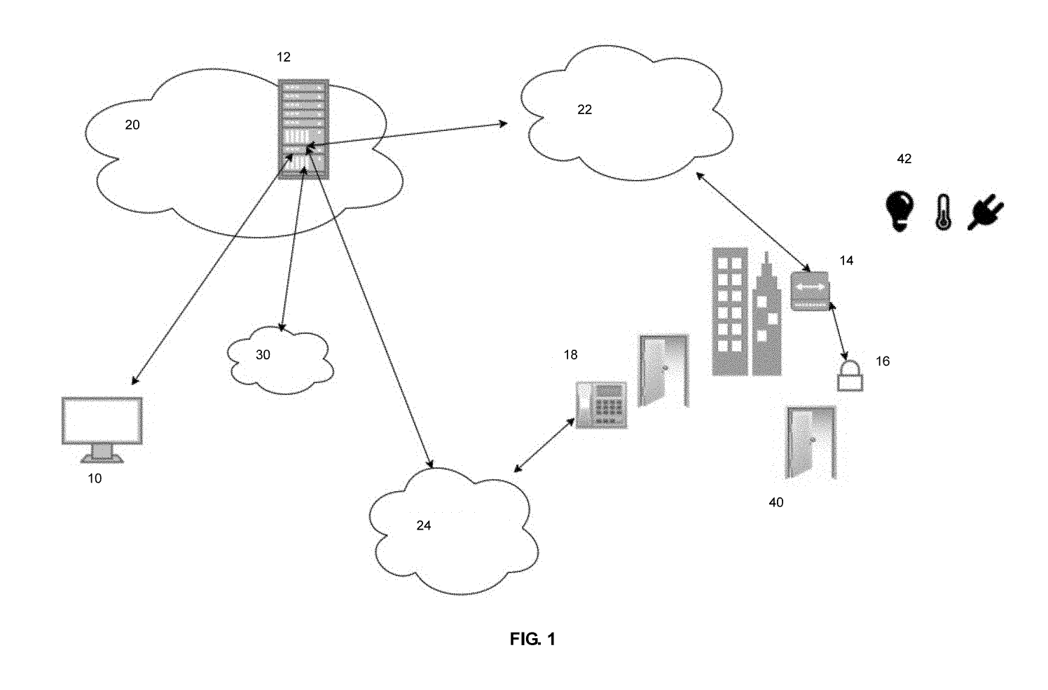

FIG. 1 illustrates a system for remote control of one or more operational characteristics of a premises in accordance with embodiments of the present invention. The system comprises a central server 12, which is configured to provide a user 10 access to and control of one or more of the operational characteristics of a premises 41. The central server is further configured to provide a system for validation of authorization of a request to change one or more operational characteristics of a premises.

For example, a user 10 via a computing device and associated user interface, can remotely access the central server via a communication network 20 for example the Internet, and provide a notification of a desired change to one or more operational characteristics of the premises. The central server upon verification of the user, can transmit one or more commands to a local hub 14, operatively associated with the premises, to coordinate the desired change to one or more operational characteristics 42. The coordination of the desired change by the local hub can include transmission of instructions to one or more controllers associated with devices that control the one or more characteristics to perform the respective change. For example, a desired change can be one or a combination of adjustment of light levels, adjustment of heating level, enabling access to the premises or other operational characteristic of the premises. As an example, a desired change can relate to heating and the local hub can send instructions to a controller associated with a thermostat in order to adjust the heating level in the premises.

As another example, a user can provide a guest thereof with a security clearance to request a change to one or more operational characteristics of the premises, e.g, access to the premises. In this instance, the guest can interact with an interface 18, for example an intercom, that is communicatively connected to the central server. This communicative connection between the interface and the central server can be provided by a communication network 24 including the Internet or public switched telephone network or other communication network as would be readily understood. Via the interface, the guest can provide a security code indicative of the security clearance, to the central server. The central server upon verification of the security clearance, can transmit, one or more commands to a local hub 14, operatively associated with the premises, to coordinate the desired change to one or more operational characteristics of the premises, for example opening of a smart lock 16 associated with the premises, thereby providing the guest with access to the premises.

According to some embodiments, the local hub 14 and the central server 12 can be communicatively linked by a public communication network, a private communication network or a combination thereof. In some embodiments, the local hub is securely connected to a hub network 22, for example a secure hub cloud, which can be accessed by the central server. In this manner, the central sever and the hub are provided with substantially secure communication therebetween. In addition, the hub can transmit information and details regarding one or more operational characteristics of the premises to the hub network for access by the central server. In this manner the central server does not have to directly communicate with the hub in order to obtain the information and details. It will be readily understood that plural local hubs can communicate with the hub network, thereby providing the central server with a centralized location to query in order to obtain information and details relating to plural premises. Furthermore, this can provide the central server with a means to obtain information and data to log or maintain data indicative of access to a premises, operational characteristics modified or other information which may be provided by the local hub.

According to some embodiments, the security code indicative of the security clearance can be entered in an input device associated with the interface. In some embodiments, the interface can include a microphone and the guest can input the security code verbally. For a verbally entered security code, the interface can communicate the verbal entry to the central server which can activate an internal voice recognition system in order to determine or transcribe the specific security code verbally entered by the guest. In other embodiments, the central server can be communicatively linked to a 3rd party voice transcription service 30 which can determine or transcribe the security code verbally entered by the guest for subsequent provision to the central server for determining authorization of the guest to request the adjustment or change in one or more operational characteristics of the premises.

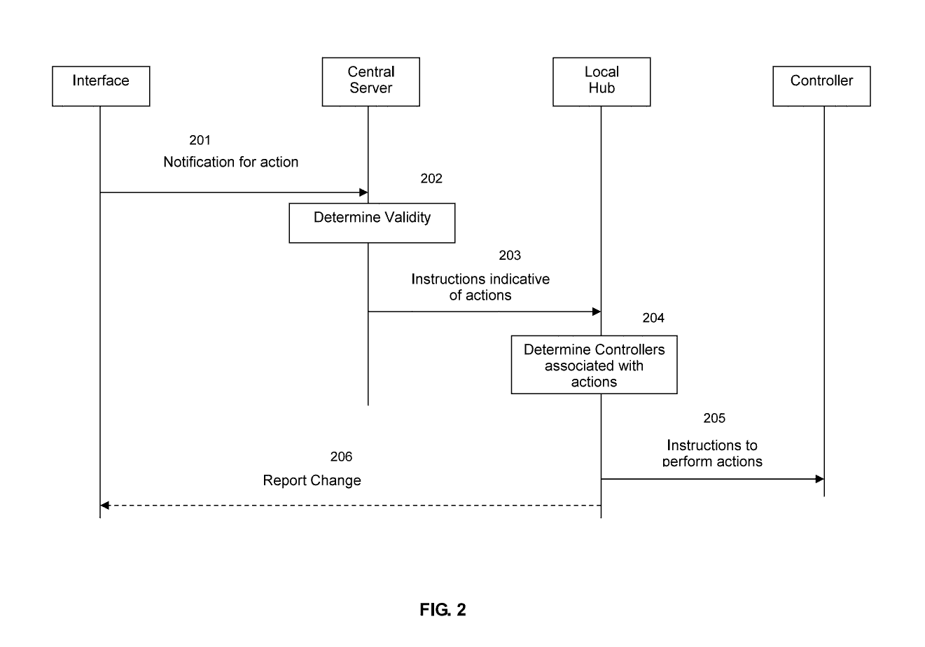

FIG. 2 illustrates a signalling diagram for remote control of one or more operational characteristics of a premises in accordance with embodiments of the present invention. A user via a user interface, communicates 201 a notification to the central server in order to initiate an action in relation to one or more operational characteristics of the premises. The central server, upon receipt of the notification, determines 202 the validity of the notification. The validity of the notification can involve the determination of the user's authority to request a change to one more operational characteristics. As would be understood, the notification can include therein one or more identifiers which provide the central server with the ability to cross reference the notification with one or more user specific identifiers stored thereon. In this manner the validity of the received notification can be determined. Upon validation of the notification, the central server transmits 203 instructions to the local hub which is associated with the premises to which the change of one or more operational characteristics is requested. Upon receipt of these instructions, the local hub determines 204 the one or more controllers that control the one or more operational characteristics that require modification and subsequently transmits 205 instructions to the controller or controllers associated with the one or more operational characteristics for adjustment thereof. For example, if the instructions are indicative of a temperature increase, the local hub can determine that the thermostat is to adjust the heat, and the local hub can transmit suitable instructions to the thermostat to perform the requested adjustment to the heating system. According to some embodiments, the local hub will report 206 changes to the central server or for collection by the central server via a hub network, wherein the changes can relate to the operational characteristics of the premises. For example the hub can report access to the premises, report changes in temperature of the premises or other change in the operational characteristics of the premises.

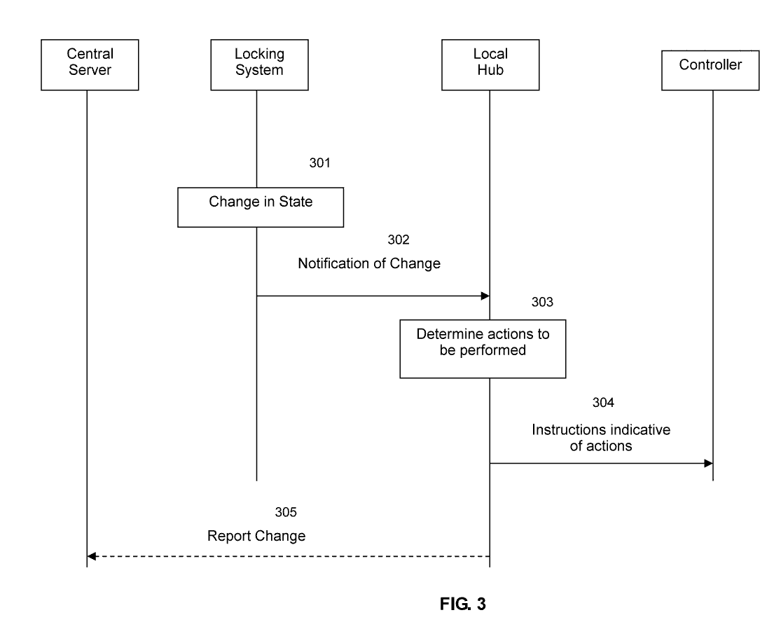

FIG. 3 illustrates a signalling diagram for remote control of one or more operational characteristics of a premises in accordance with embodiments of the present invention. A locking system changes 301 from a first state to a second state and the locking system subsequently transmits 302 a notification to the local hub indicating this change in state. Upon receipt of this notification, the local hub determines 303 one or more actions to be performed in light of the transition of the locking system as well as a determination of the one or more controllers associated with the determined one or more actions. The local hub subsequently transmits 304 instructions to the one or more controllers which are capable of performing or initiating the determined one or more actions. For example, upon the transition of a locking system from an open state to a closed state, desired actions can include ensuring all lights have been turned off, reduction of heat to a predetermined minimum, turning off a TV, activating an alarm system, or other operational characteristic or combination thereof. The local hub determines these actions based on the state transition of the locking system, and subsequently transmits instructions to each of the controllers associated with the determined actions, in order to ensure that each of the operational characteristics are set at the desired level. According to some embodiments, the local hub will report 305 changes to the central server or for collection by the central server via a hub network, wherein the changes can relate to the operational characteristics of the premises. For example, reporting access to the premises, reporting changes in temperature of the premises or the like.

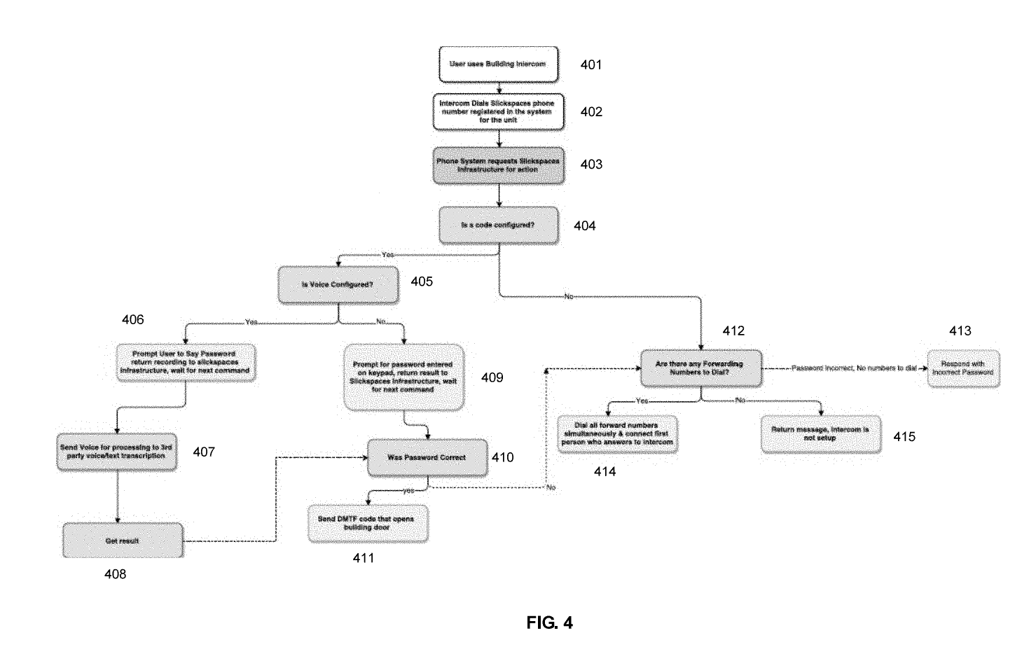

FIG. 4 illustrates a logic flow diagram for provision of guest access to a premises in accordance with embodiments of the present invention. A guest reaches a building into which they desire entrance. Using the building intercom 401, the guest enters a request for access to a particular premises, for example by entering the room number of the premises. The intercom connects 402 with the central server based on a preregistration of the particular premises with the central server. Upon connection with the central server, the intercom provides the central server with the access request 403. The central server determines 404 if the premises is code configured, for example if the premises has associated therewith a passcode for modifying one or more characteristics of the premises. If the premises is not node configured, the central server determines 412 if there are any forwarding numbers to dial. For example, these forwarding number can be associated with the user who has provided the guest with the authorization to access the premises. If the central server determines that there are no forwarding numbers, a response is sent 413 to the intercom indicating that access is denied. Alternately, if there are forwarding numbers, the central server interconnects the intercom with the first forwarding number that answers 414 the intercom call. In this manner the guest is connected with a person authorized by the user to determine if the guest has authorization to enter the premises. However, if there are no responses from the forwarding numbers, the central server responds 415 with a response to the intercom that the setup is incomplete.

According to embodiments, when the central server determines 404 that the premises is code configured, the central server determines 405 if the premises is configured for voice authorization. If the premises is not configured for voice authorization, the central server prompts 409 the intercom to request a passcode or password. Upon entry of a passcode or password by the guest, the central server determines 410 if the passcode or password is correct and if so the central server transmits instructions to the intercom to provide access to the premises 411. However, if the password or passcode is determined to be incorrect, the central server with follow the process noted above with respect to forwarding numbers 412.

According to embodiments, if the central server determines 405 the premises is configured to voice authorization, the central server prompts 406 the intercom to request the password or passcode verbally from the guest. Upon verbally entering the password or passcode by the guest, the central server can subsequently internally perform voice recognition 407 or have a third party perform voice recognition in order to obtain the passcode or password. The central server can obtain 408 the result of the determined passcode or password and the central server can determine 410 if the passcode or password is correct. If the passcode or password is correct, the central server transmits instructions to the intercom to provide access to the premises. However, if the password or passcode is determined to be incorrect, the central server with follow the process noted above with respect to forwarding numbers 412.

According to embodiments, a passcode or password provided to a guest can enable only certain operational characteristics of the premises to be modified. For example, when the premises is a residential tower, a passcode or password, upon validation thereof, may only enable the guest to enter a building and only have access to a particular floor of the building upon entry into an elevator. In this manner by limiting access, a level of security upheld for other areas of the building.

According to embodiments, the modification of one or more operational characteristics may occur all at the same time or may be performed in a temporal manner. For example, upon validation of a passcode, the building door may be unlocked, however the elevator may not be activated for a predetermined amount of time, for example to account to travel time of the guest from the building door to the elevator. This temporal modification of the operational characteristics can also provide for a delay of apartment door unlocking.

According to some embodiments, upon receipt of a notification a local hub can perform one or more actions relating to the operational characteristics of a premises, wherein these one or more actions can be defined by a schedule of actions. For example, this schedule of actions can define a timing sequence in relation to the actions, a sequence in which the actions are to be performed or other schedule of actions as would be readily understood.

According to some embodiments, a user can provide authorization for provision of guest access to a premises based on preauthorized command being received by a building intercom. For example, a user has knowledge that a guest will be arriving at a building at a predetermined time, and the user initiates, via the central server, the transmission of a preauthorization to the intercom, such that the intercom can automatically provide access to the building at the predetermined time. In some embodiments, the preauthorization received by the intercom can include information relating to one or more of the actions to be taken by the intercom, a time window within which these actions are to be taken or other action to be performed by the intercom.

According to embodiments, the one or more characteristics that can be adjusted, can relate to the functionality associated with the locking system. For example, the characteristics can relate to the changing of programming codes associated with the locking system, changing locking functionality, managing relocking time, providing action codes, changing sound level, changing language, resetting to factory settings and changing of lighting, or changing of other functionality that can be associated with a smart lock locking system.

According to embodiments, the one or more characteristics that can be adjusted can relate to the functionality associated with the locking system and in particular to the changing of programming codes associated with the locking system. For some locking systems, upon installation, the user code or codes remains in the locking system and as such may pose a safety issue. According to embodiments, the locking system is configured such that the user code or codes can be changed remotely, for example changed by the central server via the local hub. In some embodiments, if servicing of the locking system is required, a temporary user code can be associated with the locking system, via the central server, which can allow a locksmith, or other trade access to the locking system for service.

According to embodiments, the one or more characteristics that can be adjusted can relate to the functionality associated with the locking system and in particular to changing locking functionality. According to embodiments, the locking system is configured such that the deadbolt and or lever lock can automatically lock after it has been unlocked, wherein this modification can be made remotely, for example changed by the central server via the local hub. This configuration of the locking system may be useful in an instance wherein a guest requests that the auto-lock feature be turned off.

According to embodiments, the one or more characteristics that can be adjusted can relate to the functionality associated with the locking system and in particular to adjusting relocking time. According to embodiments, the locking system is configured such that the time period for the door to automatically lock after being unlocked can be changed remotely, for example changed by the central server via the local hub.

According to embodiments, the one or more characteristics that can be adjusted can relate to the functionality associated with the locking system and in particular to providing action codes which when entered into the locking system can cause the locking system to initial one or more actions. According to embodiments, the locking system is configured such that the one or more codes can be programmed into the locking system, wherein each these one or more codes can initiate at least a particular action being performed, when the codes is entered into the locking system. For example, a first code can result in a text or email being sent to indicate that the unit has cleaned and it thus ready for a subsequent guest. Another code may result in a text or email to indicate that the unit has been repaired. Another code may result in the disablement or activation of a room or home-based security system, which may include motion sensors, noise sensors or other security sensors. Another code may result in the transmission of a request for an extension of check-out for example a request for a 1 hour or 30-minute extension to the check-out time. Another code may result in the transmission of a request for towels, pillows or other products to be delivered to that particular premises. It will be readily understood that while these codes have been discussed as being associated with a particular action being performed, a particular code may result in plural actions being performed. Moreover, it will be readily understood that these are merely example of potential actions initiated by the input of a particular code into the locking system, and these example actions are to be considered as non-exhaustive.

According to embodiments, the one or more characteristics that can be adjusted can relate to the functionality associated with the locking system and in particular to changing sound level associated with the locking system. According to embodiments, the locking system is configured such that the sounds made by the locking system or the sound level can be changed remotely, for example changed by the central server via the local hub.

According to embodiments, the one or more characteristics that can be adjusted can relate to the functionality associated with the locking system and in particular to changing the language used by the locking system, for example the verbal cues provided by the locking system. According to embodiments, the locking system is configured such that the language of verbal cues from the locking system can be changed remotely, for example changed by the central server via the local hub. In some embodiments, upon booking a guest may requests a particular language of correspondence, and the locking system may be automatically configured in this manner for this particular guest. In some embodiments, if the guest interacts with an intercom for access to the building, the central server, via the local hub can set the language associated with the locking system such that it is compatible with the language used by the guest during interaction with the intercom.

According to embodiments, the one or more characteristics that can be adjusted can relate to the functionality associated with the locking system and in particular to resetting to factory settings of the locking system. According to embodiments, the locking system is configured such that the locking system can be reset to factory default or any integrated functionality can be remove, wherein these actions can be performed remotely, for example changed by the central server via the local hub.

According to embodiments, the one or more characteristics that can be adjusted can relate to the functionality associated with the locking system and in particular to changing of lighting conditions associated with the locking system. According to embodiments, the locking system is configured such that a lighting system which may be associated with the locking system may be adjusted, dimmed, brightened or the like wherein this change can be made remotely, for example changed by the central server via the local hub.

According to embodiments, the local hub is operatively connected with a voice recognition system. For example, the voice recognition system is integrated within the local hub or the voice recognition system is communicatively connected with the local hub. In this configuration, verbal commands relating adjustment of a characteristic of the premises can be provided to the voice recognition system, wherein the voice recognition system can subsequently provide a suitable command to the local hub to adjust the one or more characteristics of the premises defined by the verbal command. For example, a person within the premises can issue a voice command to decrease the ambient temperature to a particular level. The voice recognition system resident on the local hub or communicatively connected to the local hub, provides a command indicative of the verbal command to the local hub. The local hub subsequently transmits a command to the communicatively connected thermostat located within the premises to adjust the temperature accordingly. As would be readily understood, while the above example discusses temperature, the verbal commands can be indicative of a desired change to one or more of a variety of operational characteristics of the premises. According to embodiments, the voice recognition system is activated upon the unlocking of the locking system associated with the premises.

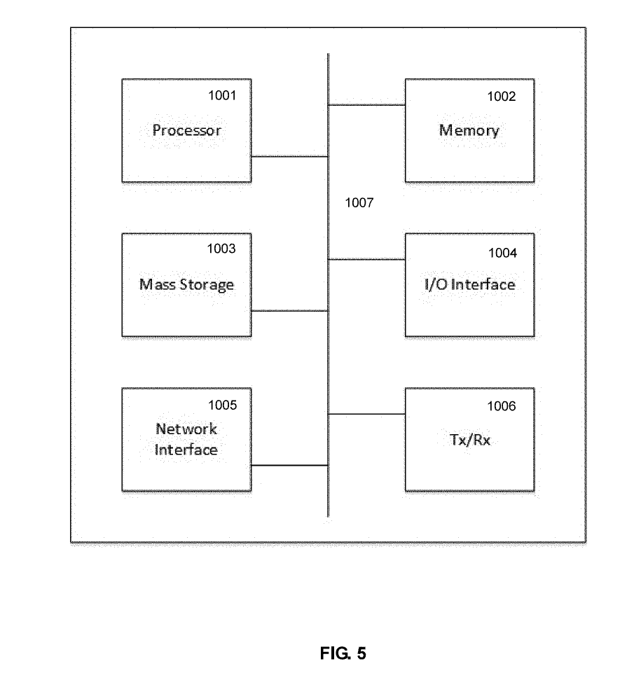

FIG. 5 is a schematic diagram of a hardware device that may for example, include a central server or a local hub or other computing device, or perform any or all of steps of the above methods and features described herein, according to different embodiments of the present invention. As shown, the device includes a processor 1001, memory 1002, non-transitory mass storage 1003, I/O interface 1004, network interface 1005, and a transceiver 1006, all of which are communicatively coupled via bi-directional bus 1007. According to certain embodiments, any or all of the depicted elements may be utilized, or only a subset of the elements. Further, device may contain multiple instances of certain elements, such as multiple processors, memories, or transceivers. Also, elements of the hardware device may be directly coupled to other elements without the bi-directional bus.

The memory may include any type of non-transitory memory such as static random access memory (SRAM), dynamic random access memory (DRAM), synchronous DRAM (SDRAM), read-only memory (ROM), any combination of such, or the like. The mass storage element may include any type of non-transitory storage device, such as a solid state drive, hard disk drive, a magnetic disk drive, an optical disk drive, USB drive, or any computer program product configured to store data and machine executable program code. According to certain embodiments, the memory or mass storage may have recorded thereon statements and instructions executable by the processor for performing any of the aforementioned method steps described above.

Through the descriptions of the preceding embodiments, the present invention may be implemented by using hardware only or by using software and a necessary universal hardware platform. Based on such understandings, the technical solution of the present invention may be embodied in the form of a software product. The software product may be, stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We Claim:

1. A method for remote control of one or more operational characteristics of a premises, the method comprising:
receiving, by a central server, a notification for an action to be performed, the action relating one or more operational characteristics of the premises;
determining, by the central server, validity of the notification; and
transmitting, by the central server, instructions indicative of the action to be performed upon determination of validity of the notification.

2. The method according to claim 1, further comprising retrieving, by the central server, change data indicative of the one or more operational characteristics.

3. The method according to claim 1, further comprising receiving, by the central server, a request for access.

4. A server for remote control of one or more operational characteristics of a premises, the server comprising;
a processor; and
machine readable memory storing machine executable instructions which when executed by the processor configure the server to:
receive a notification for an action to be performed, the action relating one or more operational characteristics of the premises;
determine validity of the notification; and
transmit instructions indicative of the action to be performed upon determination of validity of the notification.

5. A method for remote control of one or more operational characteristics of a premises, the method comprising:
receiving, by a local hub, a notification from a locking system, the notification indicative of a transition of the locking system from a first state to a second state;
determining, by the local hub, one or more actions to be performed, the one or more actions indicative of a desired change in the one or more operational characteristics due to the transition of the locking system; and
transmitting, by the local hub, one or more commands indicative of the one or more actions.

6. The method according to claim 5, further comprising transmitting, by the local hub, change data indicative of the one or more operational characteristics.

7. The method according to claim 5, wherein plural actions are to be performed and wherein the plural actions are to be performed have a temporal variation.

8. The method according to claim 5, wherein plural actions are to be performed and wherein the plural actions are performed based on a predetermined schedule.

9. The method according to claim 5, wherein the one or more actions to be performed includes activation of a voice recognition system operatively connected with the local hub.

10. A hub for remote control of one or more operational characteristics of a premises, the hub comprising:
a processor; and
machine readable memory storing machine executable instructions which when executed by the processor configure the hub to:
receive a notification from a locking system, the notification indicative of a transition of the locking system from a first state to a second state;
determine one or more actions to be performed, the once or more actions indicative of a desired change in the one or more operational characteristics due to the transition of the locking system; and
transmit one or more commands indicative of the one or more actions.

11. The hub according to claim 10, wherein the hub is operatively connected with a voice recognition system.

12. A system for remote control of one or more operational characteristics of a premises, the system comprising:
a locking system associated with the premises, the locking system transitionable between a first state to a second state;
a local hub communicatively connected to the locking system;
a controller communicatively connected to the local hub, the controller operative to control at least one of the one or more operational characteristics;
wherein the local hub is configured to transmit one or more commands to the controller upon transition of the locking system from the first state to the second state, the one or more commands indicative of a desired change in the one or more operational characteristics.

13. The system according to claim 12 further comprising a remote access interface operative on a device communicatively connected to the communication network, wherein the central controller is configured to provide status information indicative of the one or more operational characteristics to the remote access interface.

14. The system according to claim 12 further comprising a hub network configured to communicatively connect with the central server and the local hub.

15. The system according to claim 14, wherein the hub network is a secure cloud network configured to receive and store charge data indicative of the one more operational characteristics of the premises.

16. The system according to claim 12, further comprising an intercom configured to communicate with the central server, the intercom associated with a building within which the premises is located.
